(19) United States
(12) Patent Application Publication
(10) Pub. No.: US 2001/0022159 A1
(43) Pub. Date: Sep. 20, 2001

(54) Cat toy

(76) Inventors: Nancy Karen Zangle, Sterling, CO (US); Gerald Leo Zangle, Sterling, CO (US)

Correspondence Address: MERCHANT & GOULD PC, P.O. BOX 2903, MINNEAPOLIS, MN, 55402-0903, US

(21) Appl. No.: 09/770,520

(22) Filed: Jan. 25, 2001

Related U.S. Application Data
(60) Provisional application No. 60/178,449, filed on Jan. 27, 2000.

(51) Int. Cl. A01K 29/00

(52) U.S. Cl. 119/707

(57) ABSTRACT

A cat toy having a crinkly plastic film molded to and around a coiled wire scaffolding to form an elongated flexible tube. A cloth layer is attached to the interior surface of the flexible tube to accentuate the cats level of comfort as well as a cloth layer attached to the exterior surface for aesthetic pleasure. Air holes throughout the elongated tube ensure proper air flow and head regulation of a cat within the device.

### RELATED APPLICATIONS

This application claims priority of U.S. provisional application Ser. No. 60,178,449, filed Jan. 27, 2000.

### FIELD OF THE INVENTION

The present invention relates to an animal amusement device and more particularly to a toy for cats.

### BACKGROUND OF THE INVENTION

Various types of toys are used to entertain pets while their masters are at work or occupied in other matters. This is particularly true with respect to cats, where large numbers of cats spend the majority of their life within the confines of a house or other indoor facility.

Numerous toys exist to entertain cats. For example, there are chew toys, scratching posts, balls or other devices that are propelled by the cat, suspended devices that the cat bats and plays with, as well as squeeze type devices that make noise when moved or compressed. There is a continuing need in the art for additional entertainment devices, especially in light of the growing population of cats and cat owners. Against this backdrop the current device has been developed.

### SUMMARY OF THE INVENTION

In accordance with the present invention the above problems and others have been solved with an open ended tubular shaped enclosure for use as a toy for a cat or other small pet.

One embodiment of the present invention is a flexible elongated tube with a first end, a second end and a middle portion. The middle portion of the elongated tube is made from a crinkly plastic film molded to a tubular shaped coiled wire scaffolding. The crinkly plastic film emits noise when a cat or other pet moves over the crinkly plastic of the tube.

These and various features as well as advantages which characterize the present invention will be apparent from a reading of the following detailed description and a review of the associated drawings.

### BRIEF DESCRIPTION OF THE DRAWINGS

FIG. 1 is a perspective view of a cat toy in accordance with a preferred embodiment of the present invention.

FIG. 2 is a perspective view of a cat toy having a bend introduced in it in accordance with a preferred embodiment of the present invention.

FIG. 3 is a top view of a cat toy in accordance with a preferred embodiment of the present invention.

FIG. 4 is a cross section taken along line 4—4′ of FIG. 1.

FIG. 5 is a front view of an elevated end of the cat toy in accordance with a preferred embodiment of the present invention.

FIG. 6 is a side view of a cat toy in accordance with a preferred embodiment of the present invention.

FIG. 7 is a flow diagram showing operations required to make a cat toy in accordance with a preferred embodiment of the present invention.

### DETAILED DESCRIPTION OF THE PREFERRED EMBODIMENT

In general, the present invention is an open ended tubular shaped enclosure for use as a toy for pets, and in particular, for cats. A cat, or other small pet, enters at either end of the enclosure, plays within the enclosure and, when ready, exits the enclosure.

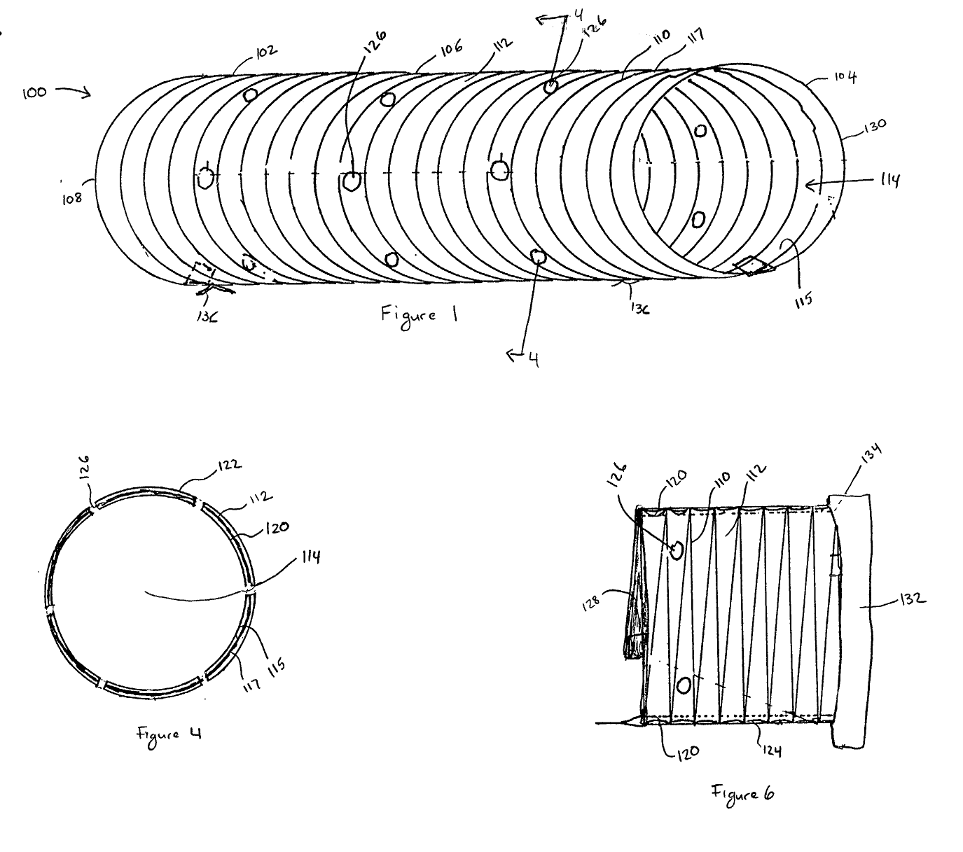

One embodiment of the present invention is shown in perspective view in FIG. 1. The device 100 is an elongated flexible tube 102 having a substantially circular cross section. The tube 102 has a first end 104, a middle portion 106 and a second end 108. The first 104 and second 108 ends of the tube 102 are typically open and of sufficient width and height for the comfortable passage of a domestic cat or other small pet. Typically, the first 104 and second 108 ends of the tube 102 have a diameter of at least 9 or 10 inches. In preferred embodiments, the diameter of each end is from about 10 to 20 inches, and most preferably from about 12 to 14 inches in diameter.

In a preferred embodiment of the present invention, the first 104 and second 108 ends of the tube 102 are substantially of equal diameter. For example, if the first end has a diameter of 15 inches, the second end has a diameter of approximately 15 inches.

The flexible middle portion 106 of the tube 102 defines an elongated tubular passage or chamber 114 having an interior surface 115. Typically, the middle portion of the tube is of a uniform shape and size and generally has a circular cross section (see FIG. 4). In preferred embodiments, the cross sectional shape and size of the middle portion 106 is substantially the same as one, and more preferably both, ends, 104 and 108, cross sectional shape and size. As such, a tube 102 that has a 15 inch diameter for its first end 104 would also have an approximate 15 inch diameter for its middle portion 108.

The extended flexible tube 102 is typically from about 24 to 72 inches in maximal length, is preferably from about 36 to 60 inches in maximal length and is most preferably from about 40 to 50 inches in maximal length. Typically, because length of the device 100 is at least partially determined by consumer demand, a series of different length devices may be made for sale, allowing the consumer to purchase a particular length device based on the confines of the use destination as well as for the enjoyment of the cat. For example, a device having a short (24 inch), medium (36 inch) or long (48 inch) length may be produced.

In general, the elongated tube 102 is formed out of a combination of coiled wire surrounded by plastic film. In preferred embodiments, the coiled wire is a spring-steel coiled wire 110 where the spring-steel coiled wire extends the length of the tube 102. The coiled wire provides a scaffolding for supporting the plastic film 112. The spring-steel coiled wire can be contorted and compressed to a wide range of positions, for example curved or in a S configuration, etc. Typically there are about from 1 to 2 number of coil revolutions for every inch of tube 102 length, and preferably about from about 1 to 1.5 coil revolutions for every inch of tube 102 length. A preferred type of spring-steel coiled wire is stainless. Typically the diameter of the wire is from about 3/64 inches to 7/64 inches although other diameter dimensions may be used. Note also that the diameter of the coiled wire scaffolding should correspond to the dimensions discussed above for the overall diameter of the two ends 104 and 108 and middle portion 106 of the tube 102.

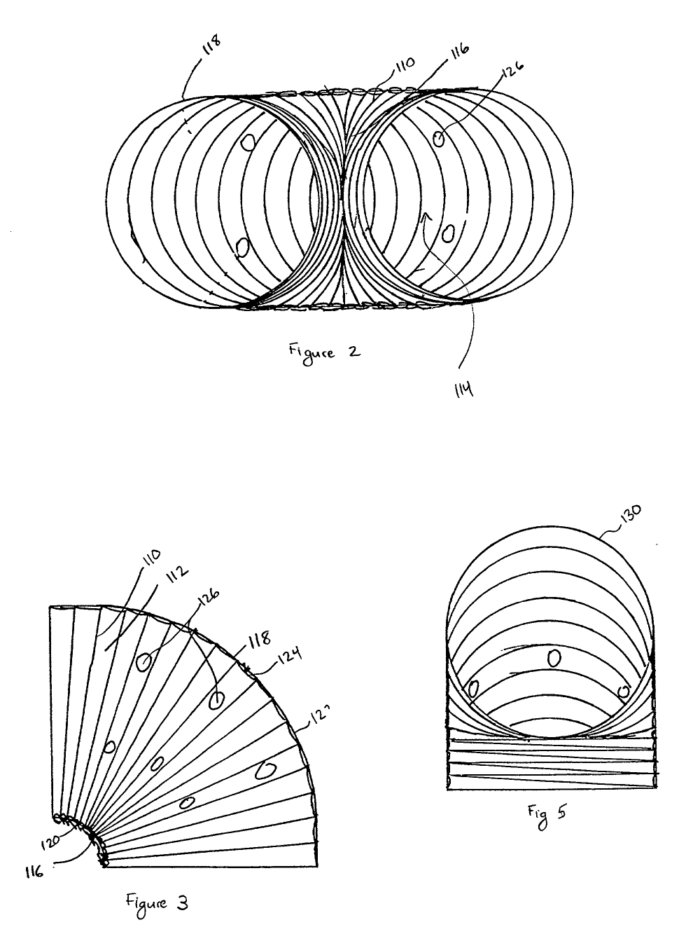

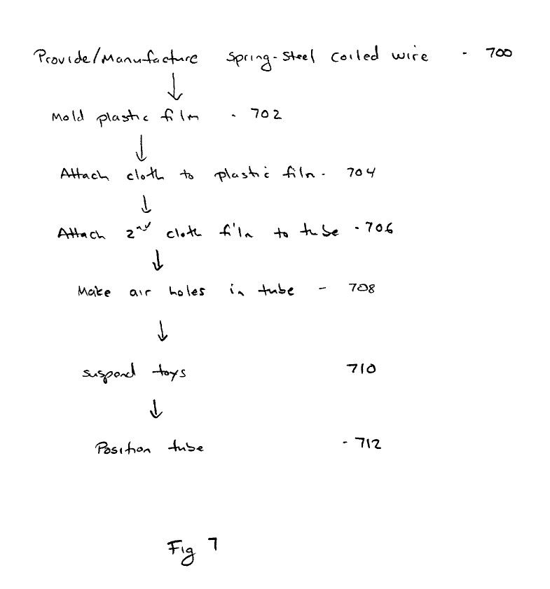

As discussed above, the plastic film is molded around and between the coiled wire. The amount of plastic film material molded around and between the coiled wire determines, to some extent, the flexibility of the tube itself. In preferred embodiments, enough plastic film is provided between the coils of wire to allow the tube to be positioned in turns and bends without causing tears or punctures to the plastic film. Upon compression of the tube 102, the plastic film folds or is pushed upon itself (see FIGS. 3 and 5). Preferred plastic films for use with the invention are ones that have a crinkly characteristic, where the plastic film emits noise when a cat or other pet moves over the film, i.e., through the passage 114 formed within the middle portion 106 of the tube 102. The plastic material can be clear, or may be colored for aesthetic appearance and privacy of the playing animal. Plastic films for use with the present invention include, but are not limited to, polyethylene, etc. A typical thickness of plastic film for use with the device 100 is from about 1 to 4 millimeters (mm), and is preferably from 1.5 to 3.5 mm in thickness and most preferably from 1.9 to 2.1 mm in thickness.

The combination of a crinkly plastic film 112 molded around a coiled wire 110 supporting structure allows the device 100 to be in any number of advantageous positions. (see FIGS. 2 and 3). This includes inclining the tube so that one end, 104 or 108, is elevated compared to the other end, 104 or 108. (see FIG. 5). In addition, the wire scaffolding allows two separate independent tubes to be attached end-to-end to each other to make one tube having twice the length. Here, one end of the first tube is rotatably compressed to telescopically engage one end of the second tube. Once the compressed end of the first tube is released it will frictionally engage the portion of the interior cavity of the second tube that it overlaps. In addition, tape or other releasable attachment means may be used to engage the two tubes together in an end-to-end fashion.

It is also noted that the make-up of the device 100 is ideal for storage in closets or other confined spaces, where the coiled wire scaffolding may be compressed upon itself. Bags, bands, cords or other such devices may be used to hold the device in a compressed state.

In another embodiment of the present invention, a layer of fabric or cloth 120 is attached to substantially the entire surface 115 of the interior passage 114 of the device 100, as is shown in the cross-sectional view of FIG. 4. The cloth layer 120 provides both a comfort (for the cat) and aesthetic quality (for the owner) to the device 100. Attachment of the cloth layer 120 to the plastic film 112 may be by adhesive, stapling, sewing, etc. The cloth layer 120 is typically taunt when the tube 102 is in an extended position and folds upon itself when the tube is in a compressed position. The device 100 should include enough fabric to allow for the flexible tubes normal positioning. In general, this is of a similar amount as the plastic film used in the device.

In some embodiments, a second cloth layer 122 is attached to the exterior surface 124 of the flexible tube 102. The second cloth layer has similar constraints as the first cloth layer, in that is should be of sufficient quantity to not interfere with the normal positioning of the flexible tube. The second cloth 122 may cover part of or the entire exterior surface 124 of the tube 102.

In another embodiment of the present invention, the second cloth layer 122 extends to overhang the first end 104 and/or second end 108 of the tube 102, thus providing an entrance flap or flaps for the tube 102(not shown).

Additionally, in another embodiment of the present invention, the cloth layer 120 that covers the interior surface 115 of the passage 114 may extend, at an the area adjacent the ground, out beyond the first and/or second end of the tube to provide a cloth mat entrance or exit way for the tube 102 (not shown).

Typical fabric thread for use in the cloth layers, 120 and 122, includes, but is not limited to, polyester, cotton, rayon, nylon, etc. It is also envisioned that multiple layers of cloth may be attached in and on the tube depending on the user's specification. It should also be noted, however, that because the crinkly plastic noise is of importance for encouraging the cat to play within the tube, the cloth layers should not be of such overall thickness that the crinkly plastic noise be essentially eliminated.

In another embodiment of the present invention, a series of air holes 126 or openings are positioned throughout the length of the middle portion 106 of the tube 102. (see FIGS. 1-6). Openings 126 are formed through the plastic film 112, and in embodiments having the cloth lining, through the cloth layers 120 and 122. The openings 126 are typically circular but may be of any shape to allow air flow/heat flow into and out of the interior cavity, for example vertical slits. Typical sized air holes 126 are from about 0.5 inches to 1.5 inches in diameter, and are preferably from about 0.75 inches to 1.25 inches in diameter. It is envisioned that at least one air hole 126 occur every foot or so of the middle portion 106, but additional air holes may occur. Further, air holes may be located anywhere on the circumference of the tube 102, but should not be located against the ground, as these air holes would be partially or totally occluded.

In another embodiment of the present invention, the first end 104 and second end 108 of the device 100 have a protective edge cover 128 that slips over and lines the edge 130 of the first end and/or second end of the tube. (see FIG. 6). The edge cover 128 protects a user from being scraped by any extending coiled wire 110 or frayed material at the end 104 and 108, and keeps the coiled wire from tearing through the plastic cover at either of the tube's ends. The edge cover 128 may be as simple as an overlapped piece of duct tape that extends from the exterior surface of the tube 124, over the edge 130, to the interior surface 115 of the passage, or may be a durable retainer clip or other receiving device having a groove that accepts the edge (not shown).

In another embodiment of the present invention, one of the two ends 104, 108 of the tube 102 is closed to provide a more secluded area for the cat to play or rest. Closure of the end 104, 108 may be accomplished by covering the end with a removable cover piece 132, for example a cover that has the corresponding shape and size as the end it fits over, and that has a flange that frictionally engages the exterior surface 124 of the tube 102 in the area 134 adjacent the end 104 and 108. The cover may be placed on and off the tube as required. In another embodiment, one of the ends of the tube is deformed so as to compress the tube walls onto themselves in the proximity of the end (not shown). The tube end is closed and held in a closed position by a clip, adhesive, or other holding device.

In another embodiment of the present invention, the device 100 is held in a position on a supporting surface by a removable adhesive 136 or other retaining/supporting device, thus minimizing any rolling type movement of the tube when in use. Note, however, that some cats may prefer that the tube 102 roll during their play and so not have the tube adhered to the ground or other support.

Note that other overall device shapes are contemplated for use with the invention. For example, in some embodiments, the elongated tube's coiled wire scaffolding has an oval cross sectional shape, or has a substantially semi-circular cross sectional shape, where the flat portion of the coiled wires sit on the ground to support the device, etc. It is envisioned that any tubular type shape be within the scope of the invention as long as the shape allows for the other novel aspects of the invention.

It is also envisioned that other materials may be used to make the device as long as the materials allow for a flexible elongated tube and for a surface of the interior chamber or passage that emits noise as the cat or other pet moves through the tube. For example, a bellows type structure lined with a crinkly type plastic.

It should be noted that string or other typical cat type toys may be suspended within the interior chamber to accentuate the play aspects of the device. Additionally, small replaceable packets of catnip may also be suspended or placed in the device to encourage a cat to enter the device and explore the tube. Suspension may be accomplished with adhesive, hooks, etc.

Finally, it is also envisioned that some embodiments of the present invention have larger chambers (not shown) formed within the walls of the middle portion of the tube. As such, the middle portion may have a diameter of 15 inches followed by a region where the diameter is 30 inches. In these expanded diameter areas or chambers the cat may rest or have a greater amount of room for play. It is also envisioned that external chambers made of plastic or other material have portals for attachment to either the first or second ends of the tube.

A method for preparing a cat toy in conformity with the present invention is shown in FIG. 7. In Operation 700, a spring-steel coiled wire of correct wire and scaffolding diameter and length is provided or manufactured. In Operation 702, a crinkly plastic film is molded to and around the spring-steel coil wire scaffolding to form an elongated tube. In Operation 704, a cloth film is attached to the interior surface of the elongated tube. In Operation 706, a second cloth film is attached to the exterior surface of the elongated tube. In Operation 708, a series of air holes are formed through the tube. In Operation 710, string or catnip is suspended within the tube. In Operation 712, the tube is positioned on a supporting surface for use by a cat or other small pet.

The above specification provides a complete description of the manufacture and use of the invention. Since many embodiments of the invention can be made without departing from the spirit and scope of the invention, the invention resides in the claims hereinafter appended.

We claim:

1. A cat toy comprising:
a flexible elongated tube having a first end, a second end and a middle portion, the middle portion having an exterior surface and an interior surface, and the elongated tube made from a crinkly plastic film molded to a tubular shaped coiled wire scaffolding, wherein movement of a cat or other pet within the elongated tube causes the emission of noise from the crinkly plastic film.

2. The cat toy of claim 1 further comprising a fabric layer attached to the interior surface of the middle portion of the elongated tube.

3. The cat toy of claim 2 further comprising a fabric layer attached to the exterior surface of the middle portion of the elongated tube.

4. The cat toy of claim 3 wherein the fabric layer attached to both the interior and exterior surfaces of the middle portion is selected from the group consisting of nylon, cotton, rayon, and polyester.

5. The cat toy of claim 1 wherein the flexible elongated tube defines at least one air hole.

6. The cat toy of claim 1 wherein the flexible elongated tube has a substantially circular cross section and the diameter of the elongated tube is from 10 to 20 inches.

7. The cat toy of claim 1 further comprising a removable cover piece, wherein the cover piece covers either the first or second end of the flexible elongated tube.

8. The cat toy of claim 1 wherein the crinkly plastic material is polyethylene.

9. The cat toy of claim 1 wherein catnip is suspended form an interior surface of the middle portion.

10. The cat toy of claim 1 wherein the flexible elongated tube is from 24 to 72 inches in length when extended.

11. The cat toy of claim 10 wherein the flexible elongated tube is from 36 to 60 inches in length when extended.

12. The cat toy of claim 1 wherein the tubular shaped coiled wire scaffolding is a spring-steel coiled wire.

13. A method of fabricating a cat toy, the method comprising the steps of:
providing a spring-steel coiled wire;
molding a crinkly plastic film to the spring-steel coiled wire to form a flexible elongated tube having an interior passage; and
attaching a cloth layer to the interior passage; and

14. The method of claim 13 further comprising attaching a second cloth layer to an exterior surface of the flexible elongated tube.

15. The method of claim 14 further comprising forming at least one air hole through the elongated tube.
